(19) United States
(12) Patent Application Publication
(10) Pub. No.: US 2023/0382630 A1
(43) Pub. Date: Nov. 30, 2023

(54) FOOD CONTAINER

(71) Applicant: Fabio SPINELLO, CODEVIGO (IT)

(72) Inventor: Fabio SPINELLO, CODEVIGO (IT)

(21) Appl. No.: 18/249,709

(22) PCT Filed: Oct. 19, 2021
(86) PCT No.: PCT/IT2021/050341

§ 371 Date: Apr. 19, 2023

(30) Foreign Application Priority Data
Oct. 20, 2020 (IT) 102020000024760

(51) Int. Cl. B65D 85/36; B65D 65/46; B65D 81/34

(52) U.S. Cl. CPC B65D 85/36; B65D 65/466; B65D 81/34; B65D 2585/366

(57) ABSTRACT

A food container including a first and a second element for the containment of food, such as pizza, made by the same mold and including a respective base with a tapered relief edge or side wall on the outer perimeter, with at least one projecting profile and at least one valley alternating on it. Furthermore, on the relief tapered edge or side wall there are circular sectors of different sizes and having, respectively, at least one beak-shaped joint and at least one hole, with a shape suitable to contain the joint. In addition, the container includes, preferably, on the entire perimeter of the element an innovative interlocking coupling system that allows a reduced height.

The present invention generally refers to a food container such as, for example, pizza.

More specifically, the invention in question relates to a container for the containment and the transport of food, of the compostable type and designed to preserve the qualities of the product contained therein and, due to its particular geometry and structure, to facilitate any transport operations, compared to the solutions known to date. Furthermore, the food container in question is suitable to be used both in conditions of high temperature, such as for heating in a traditional oven or microwave, and at low temperatures and therefore for storage in a refrigerator or freezer.

Generally, today, containers for food and, in particular, containers for pizza have a size and a geometry of the standard type, that is usually quadrangular and are only suitable for containing basically round pizzas. Furthermore, to date, the most common food containers are made of materials such as aluminum, glass, plastic and cardboard, sometimes presenting some problems that make them unsuitable for the contact with food and even harmful to the environment, since, for example, in the case of plastics, they require the use of chemical additives and petroleum derivatives.

Food containers and, in particular, pizza containers, are often made with materials unsuitable for contact with hot and/or humid foods.

An example are paper or cardboard containers which, in order to be suitable for contact with food, are coated with other materials or are surface treated with water repellents, in order to make them more durable and resistant to fluids at the expense, often, of recyclability and biodegradability.

In particular, current European regulations relating to food containers prohibit the use of materials that, through the heat emanating from the food, transfer potentially toxic chemicals from the carton to the food itself. Currently, many containers are made of recycled cellulose, even if it is prohibited by current regulations and, consequently, they contain substances that are very dangerous for health such as bisphenol A and DIBP that are released with heat and, subsequently, absorbed by the contained food.

It is for the above mentioned reasons that it is often not recommended to use the aforementioned containers in order to reheat the food once it has been delivered, or to use them for the food preservation in the refrigerator or freezer and, moreover, it is not recommended to consume the meal directly from the container since there is the risk of ingesting paper particles, glues and bleaching agents, sometimes toxic.

In addition, only in Italy, every year, around 700 million of paper or cardboard containers end up in landfills and cannot be recycled. This is due to the fact that dirty with food residues paper and cardboard can no longer be recycled as such and will therefore have to be disposed of in the mixed waste.

Moreover, if proper ventilation is not guaranteed inside the same, known-type food containers tend to encourage the generation of water vapor in excess which, by condensing, will fall on the food making it wet, rubbery, tasteless and cold.

What it is stated above implies an inconvenience precisely because, nowadays, there is no food container, in particular for pizza, which, in a single product, is able to overcome the known art problems described above. Thus, the main aim of the present invention is to make a food container, particularly for pizza, that overcomes the limitations related to the today known food containers in order to obtain a better product in many aspects.

Another purpose of the present invention is to make a food container, particularly for pizza, that is compostable since it is made of natural and biodegradable materials.

Another purpose of the invention is to realize a food container that preserves the quality of the food contained therein, thanks to specific project innovations. A further aim of the present invention is to provide a food container, such as, by way of example, pizza, that can be reused and is suitable for heating the food in conventional ovens and microwave ovens, as well as for storing the food in a refrigerator and freezer.

Another aim of the present invention is the realization of a food container, in particular for pizza, with a minimal design, compact and innovative, in which the base and the cover of the device can be made with a single mold, therefore easy to be stored, because it can be stacked; this allows to reduce the supply spaces; moreover, the pre-assembly time of known containers is eliminated, reducing, consequently, the production costs.

Not the least aim of the present invention is to realize a food container, also for pizzas having not perfectly round shapes.

These and other aims are achieved by a food container according to the attached claim 1.

Additional detailed technical features of the invention are contained in the following dependent claims.

The present invention will be now described, by way of non-limiting example, according to some of its preferred embodiments, and with reference to the appended drawings, in which:

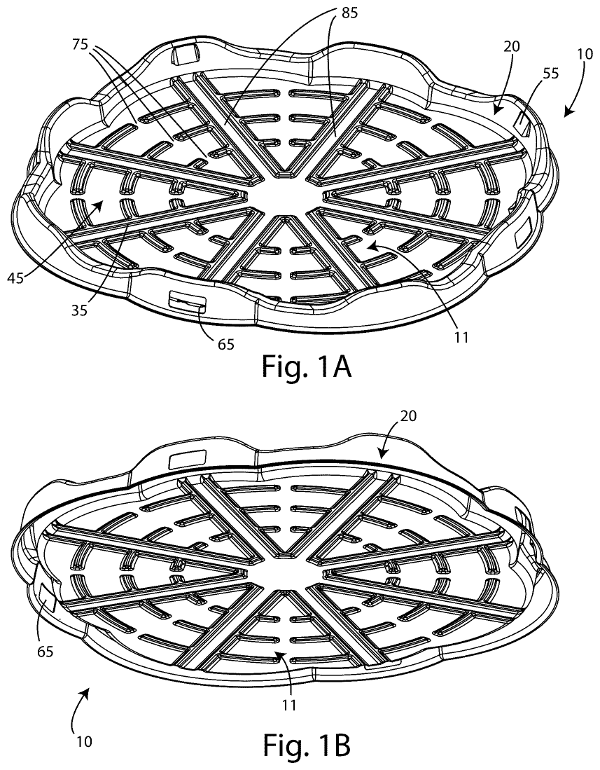

FIG. 1A is an upper perspective view of a single containment element employed in the food container, which is the object of the present invention;

FIG. 1B is a lower perspective view of the single food containment element of FIG. 1A according to the present invention;

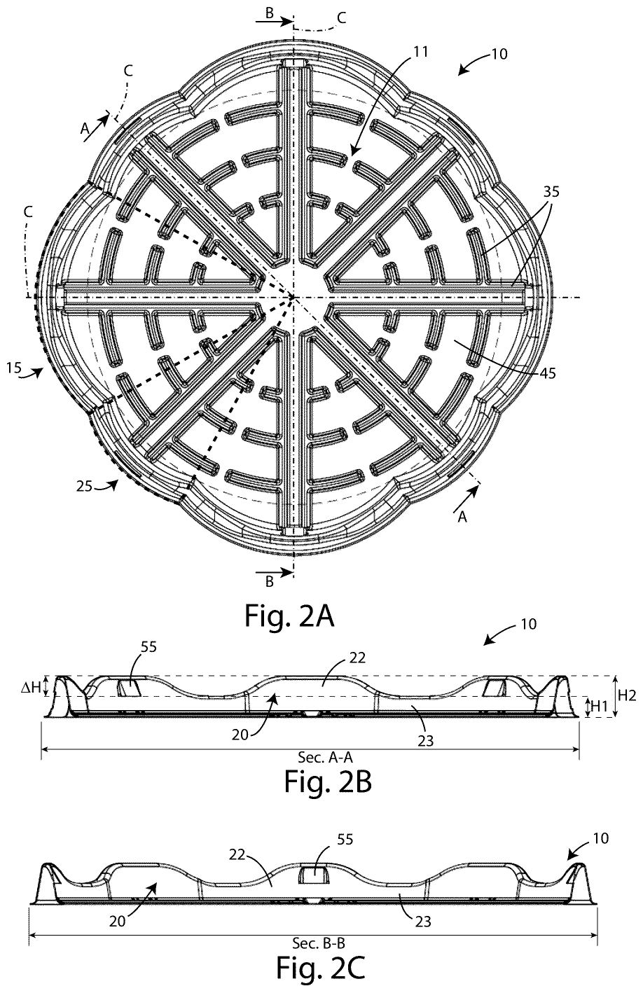

FIG. 2A is a plan view of the single food containment element of FIG. 1A, which is the object of the present invention;

FIG. 2B is a side view according to section A-A, of the single containment element for the food container of FIG. 2A;

FIG. 2C is a side view according to section B-B of the single containment element for the food container of FIG. 2A;

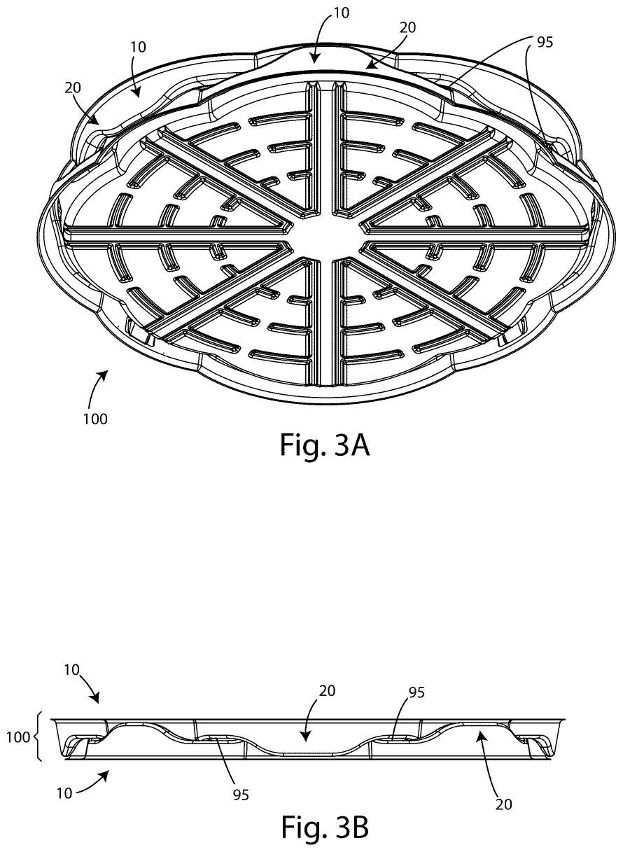

FIG. 3A is a lower perspective view of the food container, according to a first embodiment of the present invention;

FIG. 3B is a side view of the food container of FIG. 3A, according to the present invention;

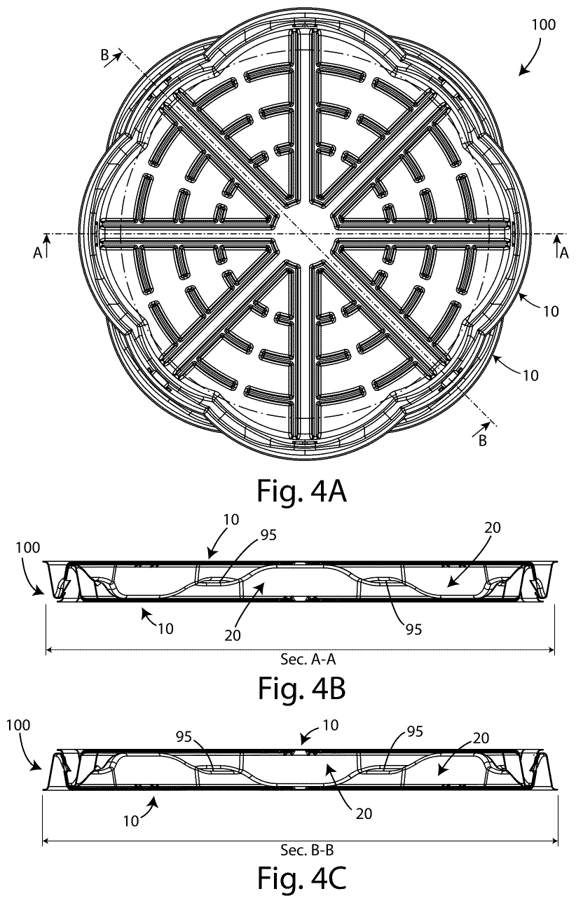

FIG. 4A is a plan view of the food container of FIG. 3A, according to the present invention;

FIG. 4B is a side view according to section A-A of the FIG. 4A food container according to the present invention;

FIG. 4C is a side view according to section B-B of the food container of FIG. 4A.

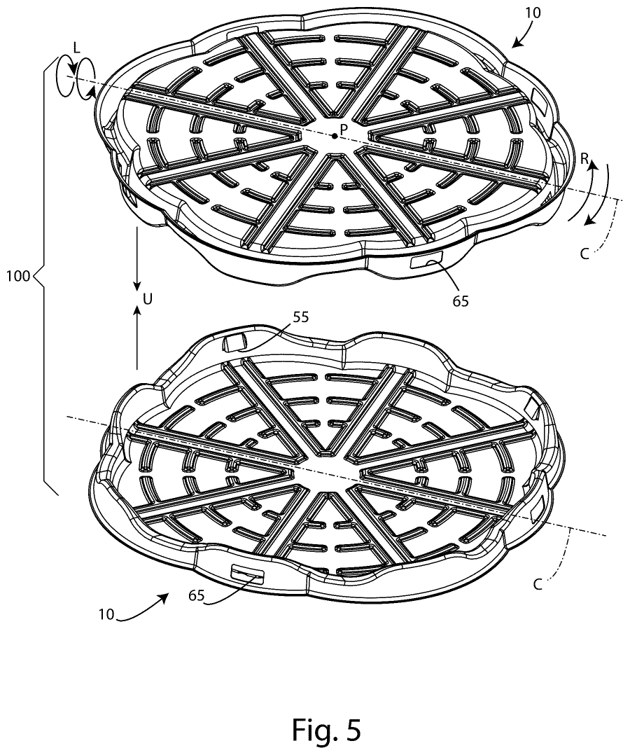

FIG. 5 shows a perspective view of two single containment elements, as in FIG. 1A, before being coupled together to make the container, which is the object of the present invention;

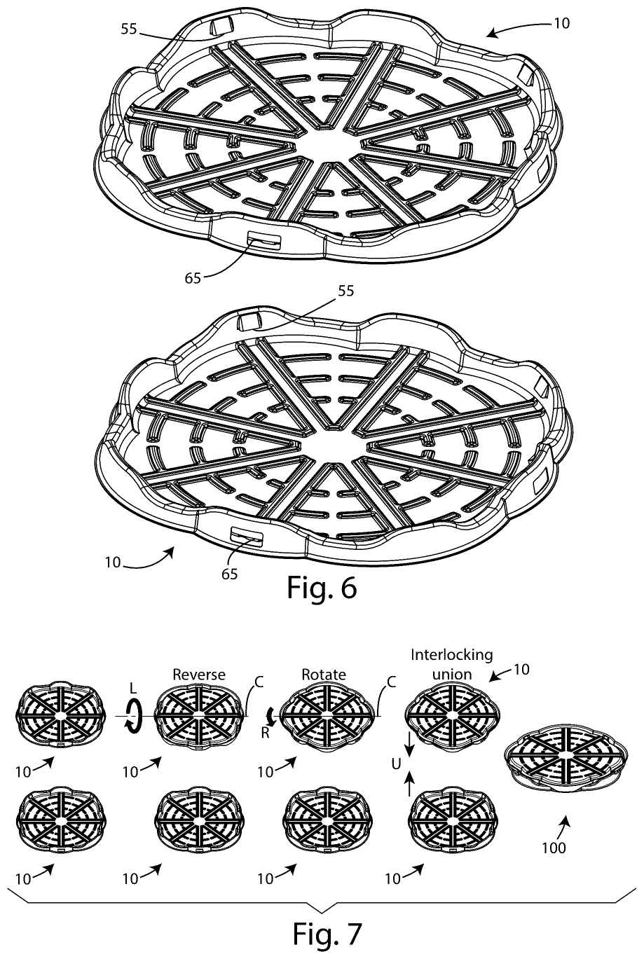

FIG. 6 shows a perspective view of two single containment elements, as in FIG. 1A, before being stacked on top of each other;

FIG. 7 shows a schematic view of the different steps related to the realization of the food container, object of the present invention, which is obtained by coupling two single containment elements.

With reference to the above-mentioned drawings, a single containing element for containing food is generically indicated with the numerical reference 10. Said single containment element 10 is made of compostable type materials and, in particular, is preferably made of cellulose pulp.

Advantageously, the single containment element 10, regardless of the chosen embodiment, it is made with a minimal design and in a single mold, reducing the production costs.

The aforementioned single containment element 10 includes a base 11 having an outer perimeter with an irregular geometry, substantially in the form of a flower corolla, in such a way as to be able to advantageously contain foods such as pizzas having not perfectly round shapes. In particular, each single containment element 10 comprises, on the relative base 11 and substantially radially, at least four first circular sectors 15, converging towards a center P coinciding with the center of symmetry of the base 11, and at least four second circular sectors 25, also converging with the center P of the base 11. Moreover, said second circular sectors 25 have a lower angular amplitude than said first circular sectors 15, as visible in FIG. 2A.

In particular, always with reference to FIG. 2A, at least one of said first circular sectors 15 is alternated with at least one of said second circular sectors 25. Advantageously, the alternation between the first sectors 15 and the second sectors 25 on the base 11 is apt to realize, at a structural level, the aforementioned flower corolla geometry that is such as to be able to advantageously contain foods such as pizzas having not perfectly round shapes.

Further, in preferred embodiments, the base 11 includes a first surface (FIG. 1A), facing the inside of the single element 10, in particular, in the area suitable to come into contact with the food, and a second flat surface (FIG. 1B), facing the outside of the single element 10, therefore in the opposite direction to the first surface, in order to allow the single element 10 to be placed on a plane. In particular, the containment elements 10, thanks to their identical geometry and structure, as visible in FIG. 6, are, advantageously, stackable one on top of the other in such a way as to facilitate storage and transport, because the supply spaces are reduced.

As can be seen, by way of example, in FIG. 2A, the base 11 of the single element 10, in correspondence with the aforementioned first surface, comprises an internal surface 45 and a supporting surface 35 which is in relief and raised with respect to the internal surface 45.

Moreover, the supporting surface 35 includes ribs with preferably radial geometries, in which all axes with inclination, preferably at 45°, depart from the center P of symmetry placed at the center of the internal surface 45 of the base 11, in such a way as to structurally create a series of ventilation channels 75 and 85, (FIG. 1A) in which, the ventilation channels 85 also allow to facilitate the cutting into slices of the food.

Moreover, the aforesaid ribs have the advantage of avoiding the food to come into contact with eventual liquids and/or oil, as well as to guide and therefore allow the escape of the steam in excess.

In particular, said ventilation channels 85 are convergent with the center P and are symmetrically developed with respect to the C-axes of the base 11, as visible in FIG. 5.

Advantageously, the single containment element 10 further has a tapered relief edge or double-walled, double-height side wall 20. Advantageously, said ridge-like side wall 20 is protuding, e.g. in angled way, from the base 11, following the entire perimeter thereof in a crown-like manner, in a substantially wavy pattern, as visible, by way of example, in FIGS. 2B and 2C.

With reference to FIG. 2B, the double-walled side wall 20 is structured to include at least one projecting profile 22 of height H2 and at least one valley 23 of height H1, according to a height variation ΔH, such that the projecting profiles 22 and valleys 23 are alternating on the side wall 20.

More specifically, on each inner wall, of the tapered side wall 20, which is located in correspondence with at least one of the at least four first circular sectors 15, there is a joint 55, preferably beak-shaped; on the other hand, on each outer wall of the tapered side wall 20, which is located in correspondence with at least one of the at least four second circular sectors 25, there is a hole preferably with a shape suitable for containing the joint 55.

Advantageously, the structure of the single containment element 10 is such that it is stackable, for example with other containment elements 10, and thus easy to be stored.

In detail, each single containment element 10 can be coupled with a further containment element 10 and, each of them can act as both a plate and as a lid in the realization of the container device 100. In addition, advantageously, each single containment element 10 acting as a lid can be stacked under the single element 10 acting as a plate during consumption; alternatively, the element 10 acting as a lid can also be used as a further plate and/or recovered for future use.

Going into detail, as schematically visible in FIGS. 5 and 7, the coupling of two containment elements 10, for the creation of the relative container device 100 closed, is obtained by reversing of 180° with respect to the axis C and, in direction L, the single containment element 10, used as a lid and, subsequently, always rotating the same containment element 10, preferably, by 45 degrees, in direction R, so as to couple it with the further element 10 acting as a plate (FIGS. 3A, 3B, 4A-4C, 5, 7); the rotation angle according to the direction R is a function of the particular geometry of the element 10. In particular, advantageously, at least two containment elements 10 are joined and coupled to each other, preferably, in the direction U perpendicular to the axis C (FIGS. 5 and 7) and have, respectively, relative first surfaces of the base 11 facing each other, so that each joint 55, as described above, of a first element 10 will couple with the corresponding hole 65 of a second contaiment element 10 and vice versa.

In fact, the food containers used today are made with a plurality of molds: a specific mold for the realization of the base of the container and one for the realization of the lid. In this way, not only the costs for the realization of the container increase but, further, since the aforesaid base and lid will have different shapes, the size of the container when closed is greater than in the technology object of the present invention.

In particular, according to the present invention, thanks to the innovative interlocking interpenetrating coupling system present, preferably, on the whole perimeter of the single element 10, when assembled, the container device 100 presents, advantageously, a smaller footprint, especially in height, and therefore a smaller thickness.

In detail, as can be seen in FIGS. 3B, 4B and 4C, in the food container device 100, thus made, there will be created, structurally, advantageously for the geometry of each element 10 acting to form the container 100, lateral slots 95, preferably eight, equidistant from each other. Advantageously, since each element 10 alternately comprises projecting profiles 22 and valleys 23, as described above, said lateral slots 95 are located at the coupling points between the two elements 10 composing the container 100, in particular said slots 95 are structurally realized at the contact point between the two valleys 23 of the two elements 10 coupled to form the container 100.

Advantageously, such slots 95 allow air exchange between the inside and the outside of the container device 100, in correlation with convective air movements, avoiding the formation of excess vapors that, by condensing, could fall on the food, altering its quality.

Alternatively, the single containment element 10 having the function of a lid can be, advantageously, used as a second course or, in case it is still intact, stored and therefore recovered. Always advantageously, for the composition of a food container device 100, no pre-assembly phase by the operator is foreseen; this allows to speed up the preparation while maintaining a safe and practical device for transport, in favor of companies that carry out delivery. In further preferred, but not limiting, embodiments, said container device 100 may be stacked with at least one additional container device 100 and/or with a single element 10.

The features of this invention, as the advantages, are apparent from the description provided; finally, it is apparent that this invention is described by way of example only, without limiting the scope of application, according to its preferred embodiments, but it shall be understood that the invention may be modified and/or adapted by experts in the field without thereby departing from the scope of the inventive concept, as defined in the claims herein.

1. A food container comprising a first and a second element for containing food in which each of said first and second element is made by the same mold and comprises a respective base with an outer perimeter with irregular geometry, in which each base comprises:
a first surface facing inside each of said first and second element for containing and suitable for contact with said food;
a second flat surface, facing the outside of each of said first and second element and in the opposite direction to said first surface;
a tapered side wall protruding with respect to said base, following all said perimeter, and in which said side wall comprises at least one projecting profile and at least one valley, so that said projecting profiles and said valleys are alternated with each other on said side wall;
at least four first circular sectors, converging towards a center coinciding with the center of symmetry of said base;
at least four second circular sectors converging towards said center of lower angular amplitude than said first circular sectors, and wherein at least one of said first circular sectors is alternated with at least one of said second circular sectors,
wherein on said tapered side wall of each of said two element, and in correspondence with at least one of said at least four first circular sectors, there is a joint in correspondence of at least one of said at least four second circular sectors, there is a hole, such that the first surface of the first element faces the first surface of the respective second element, and each joint of said first element is coupled to the corresponding hole of said second element,
wherein each of said first and second element comprises, on said respective base and substantially radially, said at least four first circular sectors, converging towards a center coinciding with the center of symmetry of said base, and said at least four second circular sectors, also converging with said center of said base, said at least four second circular sectors having a lower angular amplitude than said at least four first circular sectors and at least one of said at least four first circular sectors being alternated with at least one of said at least four second circular sectors, so as to realize a flower corolla geometry able to contain foods having not perfectly round shapes.

2. The container as claimed in claim 1, comprising lateral slots equidistant from each other, structurally realized in correspondence of the contact points between the respective valleys of said first and second element, so as to allow air exchange between the inside and the outside of the container device.

3. The container as claimed in claim 1, wherein said base of each of said two element includes an internal surface and a supporting surface for the food in relief with respect to said internal surface.

4. The container as claimed in claim 3, wherein said supporting surface comprises ribs with substantially radial geometry and passing through said center, said ribs being able to structurally create ventilation channels in which, said channels converge with said center and develop symmetrically with respect to axes of said base.

5. The container as claimed in claim 4, wherein said ribs depart from said center of symmetry with an inclination.

6. The container as claimed in claim 1, wherein said valley of each of said two element has a first height and said projecting profile has a second height, according to a height variation.

7. The container as claimed in claim 1, wherein the container is made of compostable materials.

8. The container as claimed in claim 1, wherein the container is stacked with at least one further container device and/or another single element.

9. The container as claimed in claim 1, wherein the container is configured to contain pizza.

10. The container as claimed in claim 1, wherein the joint is beak-shaped.

11. The container as claimed in claim 1, wherein the hole has a shape suitable for containing the joint.

12. The container as claimed in claim 5, wherein said ribs depart from said center of symmetry with an inclination of 45°.

13. The container as claimed in claim 7, wherein the compostable materials comprise cellulose pulp.
